(19) United States
(12) Patent Application Publication
(10) Pub. No.: US 2024/0201501 A1
(43) Pub. Date: Jun. 20, 2024

(54) HEAD-MOUNTED DISPLAY AND EYEGLASSES

(71) Applicants: Aino HASEGAWA, Kanagawa (JP); Shigenobu HIRANO, Kanagawa (JP); Yasuo KATANO, Kanagawa (JP); Masahiro ITOH, Kanagawa (JP); Takashi MAKI, Kanagawa (JP); Yoshifumi SUDOH, Kanagawa (JP)

(72) Inventors: Aino HASEGAWA, Kanagawa (JP); Shigenobu HIRANO, Kanagawa (JP); Yasuo KATANO, Kanagawa (JP); Masahiro ITOH, Kanagawa (JP); Takashi MAKI, Kanagawa (JP); Yoshifumi SUDOH, Kanagawa (JP)

(21) Appl. No.: 18/540,914

(22) Filed: Dec. 15, 2023

(30) Foreign Application Priority Data
Dec. 15, 2022 (JP) 2022-200453
Oct. 31, 2023 (JP) 2023-186818

(51) Int. Cl. G02B 27/01

(52) U.S. Cl. CPC G02B 27/0172; G02B 2027/0178

(57) ABSTRACT

A head-mounted display includes a light source to emit image light; and an optical component disposed opposite to a head, the optical component has multiple reflective surfaces arrayed in a first direction to reflect the image light to an eye in the head. At least two of the multiple reflective surfaces are disposed in a second direction tilted with respective to the first direction.

### CROSS-REFERENCE TO RELATED APPLICATIONS

This patent application is based on and claims priority pursuant to 35 U.S.C. § 119(a) to Japanese Patent Application No. 2022-200453, filed on Dec. 15, 2022 and Japanese Patent Application No. 2023-186818, filed on Oct. 31, 2023 in the Japan Patent Office, the entire disclosure of each is incorporated by reference herein.

### BACKGROUND

### Technical Field

Embodiments of the present disclosure relate to a head-mounted display and eyeglasses.

### Related Art

A known head-mounted display includes a transparent member and a semi-reflective mirror including a reflector with a reflective area that reflects image light. The transparent member allows the transmission of external light entering from the outside.

### SUMMARY

An embodiment of the present disclosure provides a head-mounted display including: a light source to emit image light: and an optical component disposed opposite to a head, the optical component has multiple reflective surfaces arrayed in a first direction to reflect the image light to an eye in the head. At least two of the multiple reflective surfaces are disposed in a second direction tilted with respective to the first direction.

An embodiment of the present disclosure provides glasses including the above head-mounted display.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a diagram of a head-mounted display worn by the user, according to one embodiment of the present disclosure.

FIG. 1B is a perspective view of the head-mounted display in FIG. 1A.

FIG. 2 is a diagram illustrating a configuration of a head-amounted display according to an embodiment of the present disclosure:

FIG. 3A is a side view of an optical unit in the head-mounted display of FIG. 1B according to an embodiment:

FIG. 3B is a perspective view of the optical unit in FIG. 3A according to an embodiment of the present disclosure:

FIGS. 4A and 4B are diagrams each illustrating an optical path of light through a head-mounted display according to an embodiment of the present disclosure:

FIG. 4C is a diagram illustrating an optical path of light through a head-mounted display according to a comparative example:

FIG. 4D is a diagram of a configuration of an optical component according to a modification of an embodiment of the present disclosure:

FIGS. 5A and 5B are other diagrams each illustrating an optical path of light through a head-mounted display according to an embodiment of the present disclosure:

FIG. 5C is a diagram illustrating an optical path of light through a head-mounted display according to another comparative example:

FIG. 6 is a diagram illustrating the spatial relationship in a head-mounted display according to an embodiment of the present disclosure:

FIGS. 7A to 7C are diagrams of an optical unit of a head-mounted display according to a modification of an embodiment of the present disclosure:

FIGS. 8A to 8C are diagrams of an optical unit of a head-mounted display according to a modification of an embodiment of the present disclosure: and

FIG. 9 is a diagram of a head-mounted display according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below: As used herein, the singular forms “a.” “an,” and “the” are intended to include the plural forms as well, unless the context clearly indicates otherwise.

According to one aspect of the present disclosure, a head-mounted display enables clear image visibility for users.

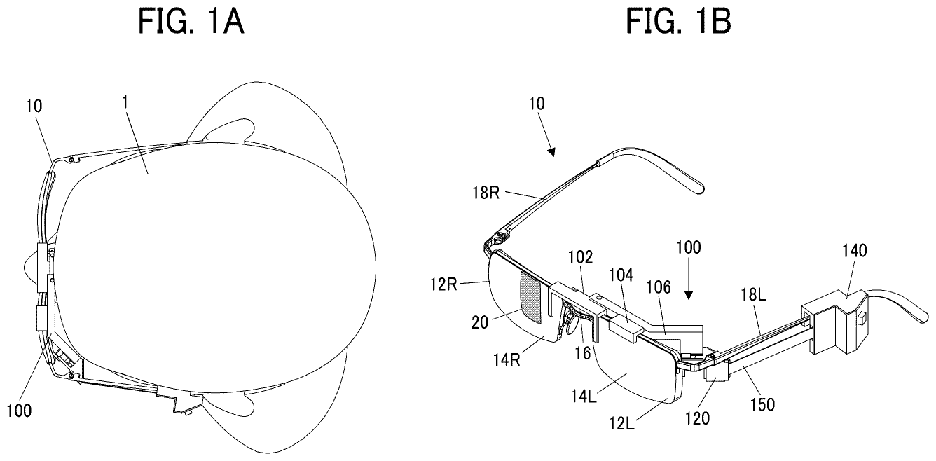

FIG. 1A is a diagram of a head-mounted display worn by the user, according to one embodiment of the present disclosure. FIG. 1B is a perspective views of the head-mounted display in FIG. 1A.

As illustrated in FIG. 1A, a head-mounted display 100 is attachable to glasses 10 and projects image light into one of the user's eyes. This allows the user to mount the head-mounted display 100 by wearing the glasses 10.

As illustrated in FIG. 1B, the glasses 10 include left and right rims 12R and 12L (or a first rim and a second rim), left and right lenses 14R and 14L, a bridge 16, left and right temples 18R and 18L, and a shielding portion 20 (or a shield) attached so as to overlap the outer side of the right lens 14R.

The head-mounted display 100 includes a first attachment 102, a second attachment 104, a connector 106, an optical unit 120, a control board 140, and wiring 150.

The first attachment 102 is mounted on the left and right rims 12R and 12L across the bridge 16. The second attachment 104 is mounted on the left rim 12L. The connector 106 connects the first attachment 102, the second attachment 104, and the optical unit 120.

With the head-mounted display 100 attached to the glasses 10, the optical unit 120 is disposed inside the left rim 12L and emits image light to the left eye of the user 1.

The control board 140 controls the image light emitted from the optical unit 120. The wiring 150 is preferably a flexible printed circuit (FPC). The wiring electrically connects the optical unit 120 and the control board 140 and transmits power and a control signal for image light from the control board 140 to the optical unit 120.

The control board 140 is attached to the temple 18L of the glasses 10. This arrangement allows for the weight of the control board 140 to not press on the nose, preventing the glasses 10 from becoming a burden regardless of long-term wear. Further, the glasses 10 incorporating the head-mounted display 100 can be designed without deviating significantly from the standard of typical glasses, achieving a natural appearance.

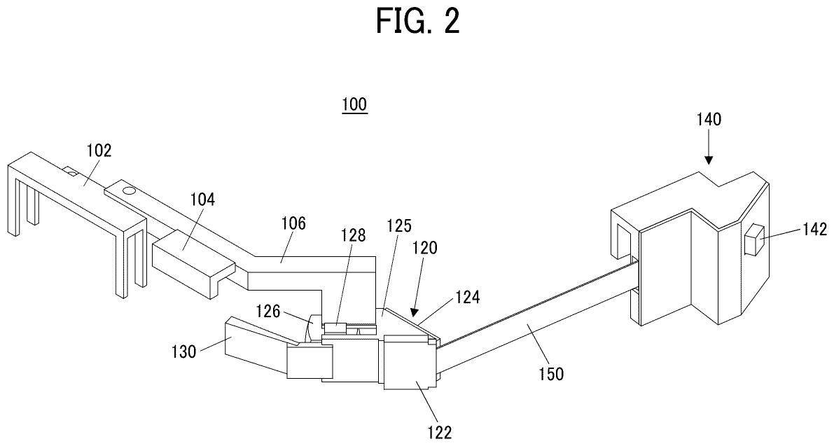

The shielding portion 20 is provided near one lens opposite to the other lens adjacent to the optical component 130 as illustrated in FIG. 2. In FIG. 1, assuming that the optical component 130 is located adjacent to the left lens 14L, the shielding portion 20 is positioned adjacent to the right lens 14R. The position of the shielding portion 20 relative to the right lens 14R corresponds to the position of the optical component 130 relative to the left lens 14L. Locating the shielding portion 20 at such a position allows for the observation of both the real space and the virtual image exclusively with the left eye over which the optical component 130 is placed. This achieves a clearer observation of the virtual image superimposed on the real space. The dimension of the shielding portion 20, such as its width, may differ from those illustrated in FIG. 1B. In some embodiments, the shielding portion 20 is not used.

In the above description, the glasses 10 include, for example, typical correction glasses, sunglasses, protective glasses, and goggles. The head-mounted display 100 may be included in a component of the glasses 10.

FIG. 2 is a diagram illustrating a configuration of a head-mounted display 100 according to an embodiment of the present disclosure.

The optical unit 120 includes a display element 122, a mirror 124, a projection lens system 126, an adjustment mechanism 128 (or an adjuster), and an optical component 130. The control board 140 includes a speaker 142.

The display element 122 is a device that emits image light. The display element 122 is preferably an organic light emitting diode (OLED) or a transmissive liquid crystal 20) display element. However, various other types of displays can be used as the display element 122. The display element 122, which serves as a light source, is, for example, an OLED. Further, the display element 122 may be a combination of a light emitting diode (LED) or a discharge lamp with a thin film transistor (TFT), a liquid crystal on silicon (LCOS), or micro electro mechanical systems (MEMS).

The mirror 124 reflects the image light emitted from the display element 122 toward the projection lens system 126. The projection lens system 126 includes, for example, multiple optical lenses and an aperture stop. The projection lens system 126 enlarges incoming image light and emits enlarged image light as parallel rays. In other words, the projection lens system 126 converts the image light into parallel rays to be incident on the optical component 130. The image light emitted from the projection lens system 126 may not be completely parallel rays and may be substantially parallel rays.

The optical component 130 directly reflects the image light emitted from the projection lens system 126 at its outer surface, directing the image light to the left eye of the user 1. The optical component 130 also allows the ambient light to pass therethrough, directing the ambient light to the left eye of the user 1. This allows the user 1 to recognize a virtual image formed with the image light, which is an image superimposed on the surrounding environment.

The optical component 130 is disposed to overlap the inner side of the right lens 14R of the glasses 10. In other words, the optical component 130 is disposed between the glasses 10 (or the right lens 14R of the glasses 10) and the eye of the user 1. This arrangement allows the glasses 10 to look natural unlike the case in which the optical component 130 is placed outside the glasses 10. Additionally, such an arrangement prevents image distortion caused by prescription lenses and darkening of the image due to light-shielding glasses such as sunglasses. The size of the shielding portion 20 illustrated in FIG. 1B in the width direction (or the lateral direction) is preferably smaller than the size of the optical component 130 in the width direction.

Further, the optical component 130 is placed close to an eye 1E, achieving both size reduction and a wide angle of view. Further, the optical component 130 may be configured to slide in the longitudinal direction. The optical component 130 may be covered by, for example, a film to prevent the optical component 130 from coming into contact with the eye 1E.

The adjustment mechanism 128 adjusts the position of the projection lens system 126 in the optical path of the image light between the mirror 124 and the optical component 130. This configuration adjusts the image-forming position of the image light, allowing for the adjustment of the position at which an image is superimposed in the surrounding environment.

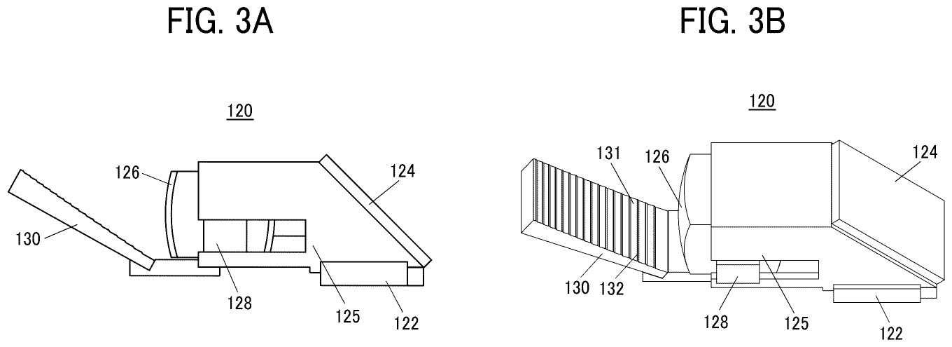

FIGS. 3A and 3B are diagrams of an optical unit 120 of a head-mounted display 100 according to an embodiment of the present disclosure.

FIG. 3A is a side view of the optical unit 120. FIG. 3B is a perspective view of the optical unit 120.

The optical unit 120 includes an optical-system casing 125 in which the display element 122, the mirror 124, and the optical component 130 are fixed in place. The projection lens system 126 is held by the optical-system casing 125 and can be moved by operating the adjustment mechanism 128.

As illustrated in FIG. 3B, the optical component 130 includes multiple transmissive surfaces 131 and multiple reflective surfaces 132, which are alternately arranged on the outer surface (i.e., the surface adjacent to the projection lens system 126) of the optical component 130. The multiple transmissive surfaces 131 transmit the ambient light, directing it to the eye of the user 1. The multiple reflective surfaces 132 directly reflect the image light, directing it to the eye of the user 1.

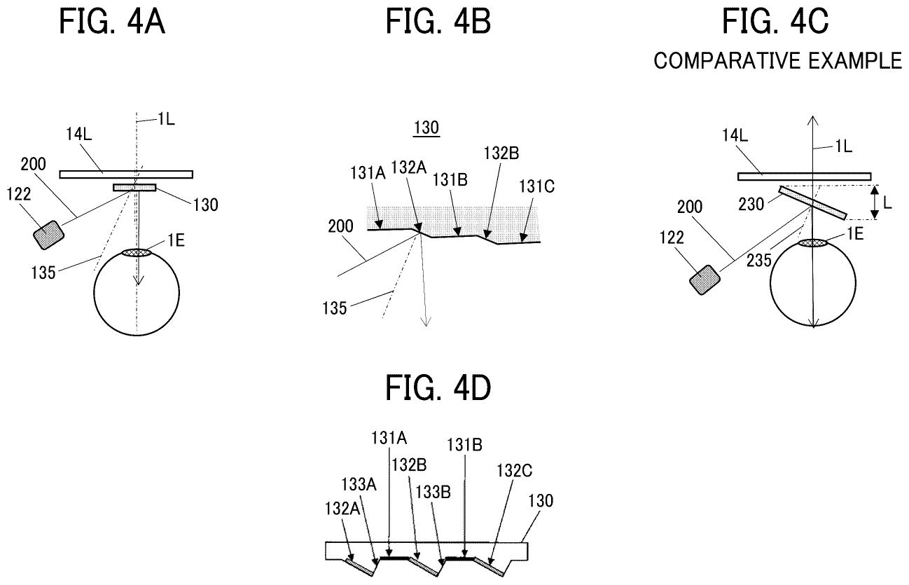

FIGS. 4A and 4B are diagrams each illustrating an optical path of light through a head-mounted display 100 according to an embodiment of the present disclosure. FIG. 4C is a diagram illustrating an optical path of light through a head-mounted display according to a comparative example.

FIG. 4A illustrates an optical path of image light when the eye 1E of the user 1 faces forward. The optical component 130 is positioned on the line of sight 1L of the user 1, overlapping the left rim 12L. The longitudinal direction of the optical component 130 is orthogonal to the line of sight 1L.

The optical component is in a longitudinal direction orthogonal to a line of sight of the eye and parallel to a first direction in which multiple reflective surfaces are arrayed.

The optical component is mounted on eyeglasses, and the optical component is disposed to have the longitudinal direction perpendicular to the line of sight of the eye when the eye faces the eyeglasses.

In this arrangement, image light 200 emitted from the display element 122 is directly reflected by the optical component 130 and directed to the eye 1E of the user 1. The image light 200, which has been made parallel by the projection lens system 126, impinges on the optical component 130. The image light 200 in FIG. 4A refers to light rays (or a light beam) output from the center pixel of the display element 122.

FIG. 4B is an enlarged view of the optical component 130. On the outer surface of the optical component 130, multiple transmissive surfaces 131A to 131C and multiple reflective surfaces 132A and 132B are alternately arranged. The transmissive surface 131 is tilted relative to the reflective surface 132 so that the angle of incidence for the image light 200 on the transmissive surface 131 is greater than the angle of incidence for the image light 200 on the reflective surface 132.

In other words, the optical component further has a transmissive surface. The transmissive surface is between adjacent reflective surfaces of the multiple reflective surfaces. A first angle of incidence of the image light on the transmissive surface is greater than a second angle of incidence of the image light on one of the multiple reflective surfaces.

Further, the transmissive surface is tilted with respect to the second direction to allow the first angle to be greater than the second angle.

In other words, the direction of the normal to the transmissive surfaces 131A to 131C substantially coincides with the direction of the line of sight 1L. The normal 135 to the reflective surfaces 132A and 132B is angled toward the direction in which the image light 200 enters, relative to the normal to the transmissive surfaces 131A to 131C.

The head-mounted display 100 including the optical component 130 as illustrated in FIGS. 4A and 4B allows the user 1 to recognize a virtual image formed by the image light, which is superimposed on the surrounding environment.

FIG. 4C illustrates an optical path of image light when the eye 1E of the user 1 faces forward according to a comparative example. In this comparative example, a semi-reflective mirror 230 is employed instead of the optical component 130 as illustrated in FIGS. 4A and 4B. The semi-reflective mirror 230 is positioned on the line of sight 1L of the user 1, overlapping the left rim 12L. The longitudinal direction of the semi-reflective mirror 230 is tilted relative to a direction orthogonal to the line of sight 1L. A reflective surface with a constant normal direction (i.e., the direction of a normal 235 is constant) is continuously formed on a surface of the semi-reflective mirror 230, which faces the user 1.

The comparative example in FIG. 4C allows the user 1 to recognize a virtual image formed by the image light, which is superimposed on the surrounding environment. However, the semi-reflective mirror 230 occupies a space of the length L in the direction of the line of sight 1L, which may cause interference with the eye 1E of the user 1.

To avoid this, the semi-reflective mirror 230 could be positioned so that its longitudinal direction is perpendicular to the line of sight 1L, in a manner similar to the optical component 130 in FIG. 4A. This, however, would cause interference between the user 1 and the display element 122 as well as the image light emitted from the display element 122, preventing the image light from reaching the semi-reflective mirror 230. As described 20) above, the head-mounted display 100 according to an embodiment of the present disclosure as illustrated in FIGS. 4A and 4B includes the optical component 130 including the reflective surfaces 132 and the transmissive surfaces 131 tilted relative to the reflective surfaces 132, which are alternately arranged on the outer surface of the optical component 130. The reflective surfaces 132 directly reflect the image light 200, directing it to the eye 1E of the user 1. This configuration reduces the possibility of interference with the eye 1E of the user 1 and allows the glasses 10 to be placed in the narrow space between the glasses 10 and the eye 1E of the user 1, achieving a clear view of the image for the user 1.

FIG. 4D is a diagram illustrating the configuration of an optical component 130 according to a modification of the above embodiment illustrated in FIG. 4A. The optical component 130 according to this modification is different from that of FIG. 4B in the position of the transmissive surfaces 131. More specifically, among the transmissive surface 131 in FIG. 4B, the line of sight L1 is positioned closer to the eye 1E of the user 1 at the transmissive surface 131 that is located farther from the display element 122. However, in FIG. 4D, the transmissive surfaces 131 are located on the same plane. In FIG. 4D, at least two reflective surfaces of multiple reflective surfaces 132 are preferably located parallel to each other. In FIG. 4D, all the reflective surfaces 132 are parallel to each other.

An optical component is disposed opposite to a head. The optical component has multiple reflective surfaces arrayed in a first direction to reflect the image light to an eye in the head, At least two of the multiple reflective surfaces are disposed in a second direction tilted with respective to the first direction.

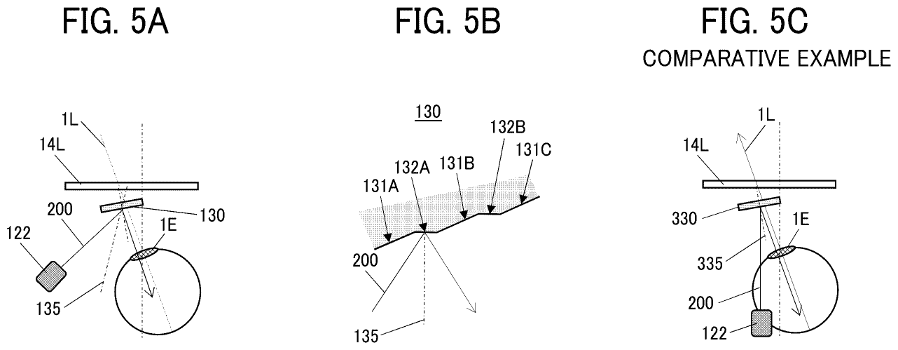

FIGS. 5A and 5B are other diagrams each illustrating an optical path of light through a head-mounted display 100 according to an embodiment of the present disclosure. FIG. 5C is a diagram illustrating an optical path of light through a head-mounted display according to another comparative example.

FIG. 5A illustrates an optical path of image light when the eye 1E of the user 1 faces in a direction tilted relative to the front. The optical component 130 is positioned on the line of sight 1L of the user 1, overlapping the left rim 12L. The longitudinal direction of the optical component 130 is substantially orthogonal to the line of sight 1L.

In this arrangement, image light 200 emitted from the display element 122 is directly reflected by the optical component 130 and directed to the eye 1E of the user 1. The image light 200, which has been made parallel by the projection lens system 126, impinges on the optical component 130. The image light 200 in FIG. 4A refers to light rays (or a light beam) output from the center pixel of the display element 122.

FIG. 5B is an enlarged view of the optical component 130. Similarly to FIG. 4B, on the outer surface of the optical component 130, multiple transmissive surfaces 131A to 131C and multiple reflective surfaces 132A and 132B are alternately arranged. The transmissive surface 131 is tilted relative to the reflective surface 132 so as to have a greater angle of incidence for the image light 200 on the transmissive surface 131 than the angle of incidence of the image light 200 on the reflective surface 132.

In other words, the direction of the normal to the transmissive surfaces 131A to 131C substantially coincides with the direction of the line of sight 1L. The normal 135 to the reflective surfaces 132A and 132B is angled toward the direction in which the image light 200 enters, relative to the normal to the transmissive surfaces 131A to 131C.

The head-mounted display 100 including the optical component 130 as illustrated in FIGS. 5A and 5B allows the user 1 with their line of sight 1L directed ahead to visually recognize the surrounding environment alone. When shifting their line of sight 1L from the front to the left of the drawing to glance, the user 1 can recognize the virtual image formed by the image light as an image superimposed on the surrounding environment.

FIG. 5C illustrates an optical path of image light when the eye 1E of the user 1 faces forward according to another comparative example. In this comparative example, a semi-reflective mirror 230 is employed instead of the optical component 130 as illustrated in FIGS. 5A and 5B. The plane mirror 330 is positioned on the line of sight 1L of the user 1, overlapping the left rim 12L. The longitudinal direction of the semi-reflective mirror 230 is tilted relative to a direction orthogonal to the line of sight 1L. A reflective surface with a constant normal direction (i.e., the direction of the normal 335 is constant) is continuously formed on a surface of the plane mirror 330, which faces the user 1.

In the comparative example of FIG. 5C, the user can recognize the surrounding environment alone when their line of sight 1L faces the front. When shifting their line of sight 1L from the front to the left of the drawing to glance, the user 1 can recognize the virtual image formed by the image light as an image superimposed on the surrounding environment. However, the display element 122 and the image light emitted from the display element 122 interfere with the user 1, preventing the image light from reaching the plane mirror 330 as illustrated in FIG. 5C.

To avoid this, the plane mirror 330 could be positioned so that its longitudinal direction is perpendicular to the front direction. This, however, causes a significant difference in optical-path length at both ends of the plane mirror 330 in its longitudinal direction, resulting in a distorted image formed by the image light.

As described above, the head-mounted display 100 according to an embodiment of the present disclosure as illustrated in FIGS. 5A and 5B includes the optical component 130 including the reflective surfaces 132 and the transmissive surfaces 131 tilted relative to the reflective surfaces 132, which are alternately arranged on the outer surface of the optical component 130. The reflective surfaces 132 directly reflect the image light 200, directing it to the eye 1E of the user 1. This configuration allows the user 1 to recognize the image.

As described above, the optical component 130 according to the above embodiments of the present disclosure has the reflective surfaces 132 and the transmissive surfaces 131 alternately arranged. Such an optical component 130 might cause the discrete lines of mirrors to become visible when moved away from the eye, making it difficult to perceive as a single image. Further, the optical component 130 could physically interfere with blinking when positioned too close to the eye. In view of such situations, the spatial relationship between the projection lens system 126, the reflective surface 132, and the eye 1E is adjusted to facilitate the perception of a single image and achieve a head-mounted display that does not hamper blinking. Further, by adjusting the angles of the reflective surface 132, a head-mounted display can be achieved that allows for easy perception of a single image and does not hamper blinking.

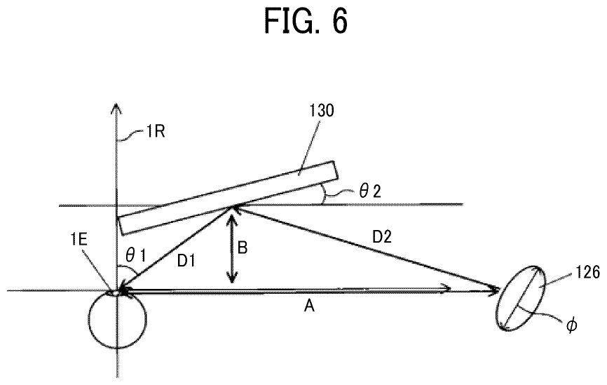

FIG. 6 is a diagram illustrating factors for adjusting the spatial relationship and the angles. The signs in FIG. 6 are as follows.
1L: the line of sight of the user 1 when the eye 1E of the user 1 faces forward
θ1: the incident angle of light impinging on the pupil of the eye 1E of the user 1
θ2: the angle of mirror (i.e., the angle of the reflective surface 132 of the optical component 130)
Φ: the diameter of the projection lens system 126
A is the distance between the center of the pupil and the projection lens system 126
B: the distance between the reflective surface 132 and the eye 1E along the line of sight L1 when the eye 1E of the user 1 faces forward
Φ: projection lens diameter (i.e., the diameter of the projection lens system 126)
D1: the optical-path length of image light between the reflective surface 132 and the eye 1E
D2: the optical-path length of image light between the reflective surface 132 and the projection lens system 126

The above sign θ2 is an angle between the reflective surface 132 of the optical component 130 and the line perpendicular to the line of sight 1L when the eye 1E of the user 1 faces forward.

The eye 1E of FIG. 6 is the right eye. Unlike the glasses 10 illustrated in FIGS. 1A and 1B, FIG. 6 is a top view of the optical unit 120 with the optical component 130 located on the right lens 14R.

The distance B is preferably within 20 millimeters (mm) between the reflective surface 132 and the eye 1E along the line of sight L1 when the eye 1E of the user 1 faces forward. More preferably, the distance B is within 12 mm. This is based on the fact that the distance between a typical eyeglass lens and the pupil (i.e., the distance between the apexes) is approximately 12 mm, and even sunglasses, goggles, or over-glasses have about 20 mm.

The projection lens diameter Φ is preferably 10 mm or less, which allows the projection lens system 126 to fit within the space between the eyeglass lens and the eye. The projection lens system 126 is preferably positioned so that the distance A between the center of the pupil and the projection lens system 126 is 45 mm or less. This allows the projection lens system 126 to be installed at a position that fits within the width of the face.

As a reflector (i.e., a mirror) is positioned further away from the pupil, the visibility of the image deteriorates. The optical-path length D1 of the image light between the reflective surface 132 and the eye 1E is preferably within 25 mm. Preferably, the reflector (i.e., the mirror) is positioned so that light reflecting off the reflector impinges on the pupil at an incident angle θ1 ranging from −10 to 60 degrees. More preferably, the reflector (i.e., the mirror) is positioned so that light reflecting off the reflector impinges on the pupil at an incident angle θ1 ranging from 0 to 30 degrees.

By adjusting the mirror angle θ2 for the reflector (the mirror) to be within the above-described range, the optical component 130 is positioned in front of the eye, expanding the displayable range of the overlaid image. At the same time, by adjusting the mirror angle θ2, the projection lens system 126 is positioned to avoid interfering with the user's face. This allows for both a higher visibility of the image and a smaller head-mounted display as a whole. In this case, the mirror angle θ2 is preferably 10 to 55 degrees, and more preferably 15 to 45 degrees.

For the optical component 130 according to an embodiment of the present disclosure, the optical component 130 is oriented substantially parallel to the eyeglasses, and the projection optical system (i.e., the optical unit 120) does not interfere with the face. In a comparative example using one semi-reflective mirror instead of the optical component 130, positioning the semi-reflective mirror in a location that avoids the interference of projection optical system with the face causes the tip of the mirror to approach too close to the pupil. In the comparative example using one semi-reflective mirror instead of the optical component 130 as illustrated in FIG. 4C, when the semi-reflective mirror is positioned substantially parallel to the eyeglasses, the projection optical system interferes with the face.

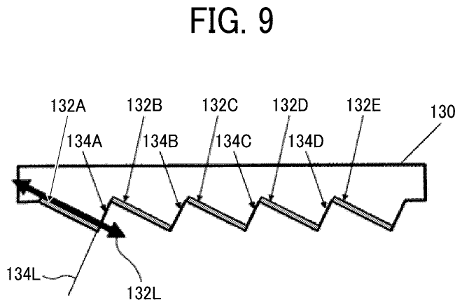

The following describes experimental examples 1 to 6, which were conducted with the optical component 130 positioned substantially parallel to the eyeglass lenses. The optical-path length D1 of the image light from the reflective surface 132 to the eye 1E was adjusted to be between 0 and 25 mm, and the optical-path length D2 of the image light from the projection lens system 126 to the reflective surface 132 was adjusted to be within 30 mm. The optical component 130 used has a shape illustrated in FIG. 9 described later.

### Experimental Example 1

When the incident angle θ1 to the pupil was set to 60 degrees and the mirror angle θ2 was set to 10 degrees, the optical-path length D1 of the image light from the reflective surface 132 to the eye 1E was 22 mm, the distance B was 11 mm between the reflective surface 132 and the eye 1E along the line of sight L1 when the eye 1E of the user 1 faced forward. The projection lens diameter Φ was 9 mm, which avoided the interference between the projection lens system and the face. This allowed the image to be clearly observed. The text is difficult to read.

### Experimental Example 2

When the incident angle θ1 to the pupil was set to 0 degrees and the mirror angle θ2 was set to 45 degrees, the optical-path length D1 of the image light from the reflective surface 132 to the eye 1E was 10 mm, and the distance B was 10 mm between the reflective surface 132 and the eye 1E along the line of sight L1 when the eye 1E of the user 1 faced forward. The projection lens diameter Φ was 7 mm, which avoided the interference between the projection lens system and the face. This allowed the image and text to be clearly observed.

### Experimental Example 3

When the incident angle θ1 to the pupil was set to 30 degrees and the mirror angle θ2 was set to 15 degrees, the optical-path length D1 of the image light from the reflective surface 132 to the eye 1E was 12 mm, and the optical-path length D2 of the image light from the projection lens system 126 to the reflective surface 132 was 30 mm. Then, the projection lens diameter Φ was 7 mm, which avoided the interference between the projection lens system and the face. The distance B was 10 mm between the reflective surface 132 and the eye 1E along the line of sight L1 when the eye 1E of the user 1 faced forward. This allowed the image to be clearly observed.

### Experimental Example 4

When the incident angle θ1 to the pupil was set to 30 degrees and the mirror angle θ2 was set to 0 degrees, the projection lens interfered with the face, causing the image to be unviewable.

### Experimental Example 5

When the incident angle θ1 to the pupil was set to −10 degrees (i.e., light impinging at a position on the pupil, further away than the distance A from the projection lens system 126 to the pupil) and the mirror angle θ2 was set to 55 degrees, the optical-path length D1 of the image light from the reflective surface 132 to the eye 1E was 11 mm, and the optical-path length D2 of the image light from the projection lens system 126 to the reflective surface 132 was 40 mm. Then, the projection lens diameter Φ was 9 mm, which avoided the interference between the projection lens system and the face. This allowed the image to be clearly observed.

### Experimental Example 6

When the incident angle θ1 to the pupil was set to −30 degrees (i.e., light impinging at a position on the pupil, further away than the distance A from the projection lens system 126 to the pupil) and the mirror angle θ2 was set to 50 degrees, the optical-path length D2 of the image light from the projection lens system 126 to the reflective surface 132 was 40 mm. Then, the projection lens diameter Φ was 9 mm. This avoided the interference between the projection lens system and the face, but causes visual rivalry, making it difficult to clearly observe the image.

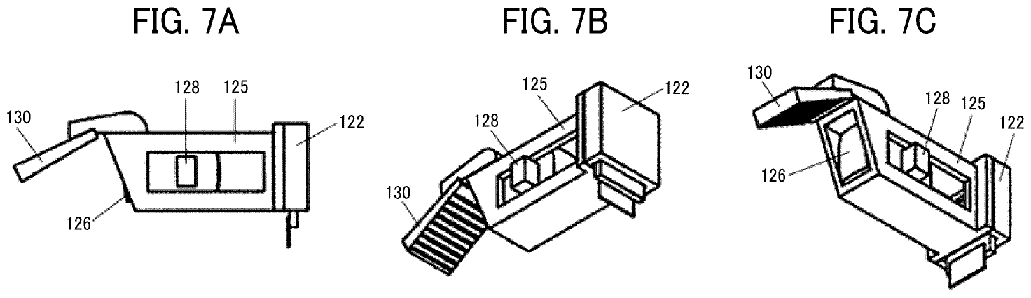

FIGS. 7A to 7C are diagrams of an optical unit 120 according to a modification of the above embodiments of the present disclosure. The optical unit 120 in FIGS. 2, 3A, and 3B reflects the image light 200 from the display element 122 once by the mirror 124 and then introduces the light into the projection lens system 126. In this configuration, focus adjustment was achieved by using the adjustment mechanism 128 to slide the projection lens system 126 within the optical-system casing 125 toward or away from the reflector.

In the optical unit 120 in FIGS. 7A, 7B, and 7C, the display element 122 and the projection lens system 126 are aligned along the same axis to allow light from the display element 122 to travel directly from the display element 122 to the projection lens system 126 without the reflection at the mirror. The adjustment mechanism 128 for focus adjustment, as in the optical unit 120 of FIGS. 2, 3A, and 3B, slides the projection lens system 126 along the direction of the optical axis within the optical-system casing 125.

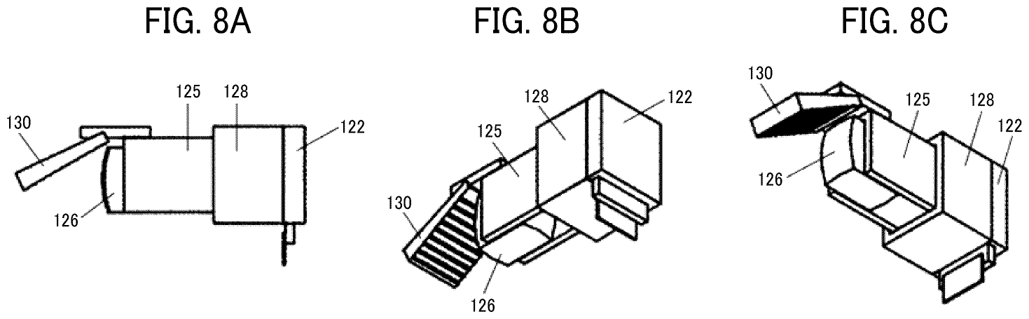

FIGS. 8A to 8C are diagrams of an optical unit 120 according to a modification of the above embodiments of the present disclosure. The optical unit 120 in FIGS. 8A to 8C differs in the adjustment mechanism 128 from that of FIGS. 7A to 7C. In this configuration of FIGS. 8A to 8C, focus adjustment is achieved by sliding the display element 122 toward or away from the projection lens system 126 with a fixed distance between the projection lens system 126 and the optical component 130. In this configuration, a retainer that retains the display element 122 is slidably attached to the optical-system casing 125 while serving as the adjustment mechanism 128. In the optical unit 120 of FIGS. 8A to 8C, the optical 20) component 130 is located inside the right lens 14R (i.e., between the lens 14R and the eye 1E).

The reflective surface 132 of the optical component 130 according to the above embodiments may be a total-reflective mirror or a semi-reflective mirror. In the case of the semi-reflective mirror, unlike the total-reflective surface, the reflective surface does not completely block the field of view, and thus the external world can be visually recognized even through the reflective surface. In the case of the total-reflective mirror, reflective surfaces and transmissive surfaces are alternately arranged, and thus the external world can be visually recognized through the transmissive surfaces. This enables augmented reality (AR) overlay (i.e., through effect). The size of the reflective surface 132 (the width of one reflective surface in the horizontal direction in, for example, FIG. 4B) is wider than the visible light wavelength, 1 micrometer (μm) or more, preferably more than ten times the visible light wavelength.

In the above embodiments, the optical component 130 has reflective surfaces 132 and transmissive surfaces 131, which are alternately arranged. In some embodiments, the optical component 130 includes only multiple reflective surfaces 132 without the transmissive surfaces 131. The reflective surface may be a total-reflective mirror or a semi-reflective mirror. In the case of the total-reflective mirror, a head-mounted display is achieved that allows the user to clearly observe the image formed by image light reflected from the multiple reflective surfaces although not allowing the viewing of the external world. In the case of the semi-reflective mirror, total-reflective mirror, the external world can be clearly observed, enabling AR overlay (i.e., through effect).

FIG. 9 is a diagram illustrating the configuration of an optical component 130 including multiple reflective surfaces 132 without any transmissive surface 131. More specifically, the optical component 130 of FIG. 9 includes multiple reflective surface 132A to 132EA and connecting surfaces 134A to 134D between adjacent reflective surfaces 132. At least two of the multiple reflective surfaces are parallel to each other. In FIG. 9, all the reflective surfaces 132 are parallel to each other. The multiple connecting surfaces 134 are also parallel to each other.

In FIG. 9, by shifting the reflective surfaces 132B to 132E, which are to the right of the reflective surface 132A positioned on the leftmost edge of the reflective surfaces 132A to 132E, downward in a direction 134L parallel to the connecting surfaces 134A to 134D, the reflective surfaces 132B to 132E are arranged on a straight line 132L parallel to the leftmost reflective surface 132. The optical component 130 is arranged to allow the light reflected from the reflective surfaces 132 to be directed to the eye 1E in the direction 134L parallel to the connecting surfaces 134. This arrangement allows the multiple reflective surfaces 132 to appear continuous as viewed in the direction 134L (i.e., in a plan view perpendicular to the direction 134L), enhancing the visibility of the image formed by the image light.

The configuration of FIG. 9 is based on the configuration of FIG. 4A. In some embodiments, the upper linear surface of the optical component 130 in FIG. 9 is perpendicular to the line of sight 1L when the eye 1E of the user 1 faces forward. In some embodiments, the connecting surfaces 134A to 134D of FIG. 9 are transmissive surfaces, and the reflective surfaces 132A to 132E and the transmissive surfaces (i.e., the connecting surfaces 134A to 134D) are alternately arranged in the optical component 130.

### Aspect 1

As described above, a head-mounted display 100, mounted on the head of a user, according to an embodiment of the present disclosure includes a light source to emit image light 200; and an optical component 130 including multiple reflective surfaces 132 on the outside surface. The multiple reflective surfaces 132 reflect the image light 200 to be directed to the eye 1E of the user 1. The multiple reflective surfaces are tilted relative to a direction in which the multiple reflective surfaces 132 are arrayed.

This allows the user 1 to clearly view the image formed by the image light. Since multiple reflective surfaces are arrayed on the outer surface of the optical component, the multiple reflective surfaces reflect zeroth-order light unlike using diffraction gratings to reflect primary waves, secondary waves, or higher order light. Thus, a brighter image can be created. it differs from systems that use diffraction gratings to reflect primary waves, secondary waves, or higher order light. Instead, it reflects zeroth-order light, allowing for the creation of a brighter image. Unlike systems that use a waveguide to guide light and emit the light through a reflector at the end of the waveguide, the above configuration avoids light attenuation within the waveguide.

### Aspect 2

In the head-mounted display according to Aspect 1, at least two reflective surfaces of the multiple reflective surfaces are parallel to each other.

### Aspect 3

The head-mounted display according to Aspect 1 or 2, further includes transmissive surfaces between adjacent reflective surfaces of the multiple reflective surfaces. An angle of incidence of the image light on the transmissive surface is greater than an angle of incidence of the image light on one of the multiple reflective surfaces.

This allows the user 1 to visually recognize a virtual image formed by the image light, which is an image superimposed on the surrounding environment.

### Aspect 4

In the head-mounted display apparatus according to Aspect 3, the transmissive surfaces 131 are tilted relative to the reflective surface 132 to have a greater angle of incidence for the image light 200 from the transmissive surface 131 to the eye (i.e., pupil) than an angle of incidence for the image light 200 from the reflective surfaces 132 to the eye.

### Aspect 5

According to any one of Aspects 1 to 4, the optical component 130 is disposed with its longitudinal direction being substantially perpendicular to a direction of a line of sight 1L of the user 1. This configuration prevents a distorted image formed by the image light, which is caused by a significant difference in optical path length at both ends of the optical component 130 in the longitudinal direction. This achieves a clear view of the image for the user 1.

### Aspect 6

In the head-mounted display apparatus according to Aspect 5, the optical component 130 is disposed with its longitudinal direction substantially perpendicular to the direction of the line of sight 1L when the eye 1E of the user 1 faces forward.

This configuration reduces the possibility of interference between the head-mounted display 100 and the eye 1E of the user 1 and also reduces the occupied space in front of the eye 1E of the user 1, allowing the user 1 to visually recognize the image in a reliable manner. As a result, the optical component 130 can be disposed in a narrow space between the glasses and the eye 1E of the user 1.

### Aspect 7

The head-mounted display 100 according to any one of Aspects 1 to 6 includes a projection lens system 126 that projects the image light 200 and an adjustment mechanism 128 (i.e., an adjuster) that adjusts the position of the projection lens system 126. This configuration adjusts the image-forming position of the image light, allowing for the adjustment of the position at which an image is superimposed in the surrounding environment.

### Aspect 8

The head-mounted display 100 according to any one of Aspects 1 to 7 includes a projection lens system that projects the image: a display element in series with the projection lens system: and an adjuster that adjusts the position of the display element.

### Aspect 9

The head-mounted display 100 according to any one of Aspects 1 to 8 is mounted on the glasses 10. This allows the user to mount the head-mounted display 100 by wearing the glasses 10. The glasses 10 include, for example, typical correction glasses, sunglasses, protective glasses, and goggles.

The optical component 130 is disposed inside the glasses 10 when mounted on the glasses 10. This arrangement allows the glasses 10 to look natural unlike the case in which the optical component 130 is placed outside the glasses 10. Additionally, such an arrangement prevents image distortion caused by prescription lenses and darkening of the image due to light-shielding glasses such as sunglasses.

Further, the optical component 130 is placed close to an eye 1E, achieving both size reduction and a wide angle of view. Further, the optical component 130 may be configured to slide in the longitudinal direction. The optical component 130 may be covered by, for example, a film to prevent the optical component 130 from coming into contact with the eye 1E.

### Aspect 10

The head-mounted display 100 according to any one of Aspects 1 to 9 further includes a control board 140 that controls the image light 200. The control board 140 is mounted on a temple 18L of the glasses 10 when the head-mounted display 100 is mounted on the glasses.

This arrangement allows for the weight of the control board 140 to not press on the nose, preventing the glasses 10 from becoming a burden regardless of long-term wear. Further, the glasses 10 incorporating the head-mounted display 100 can be designed without deviating significantly from the standard of typical glasses, achieving a natural appearance.

### Aspect 11

In the head-mounted display 100 according to any one of Aspects 1 to 10, the control board 140 includes a speaker 142. This facilitates easier listening.

### Aspect 12

The head-mounted display 100 according to any one of Aspects 1 to 11 is mounted on the glasses 10.

### Aspect 13

In the head-mounted display 100 according to Aspect 12, the optical component 130 is disposed to overlap one rim 12L. The head-mounted display 100 according to Aspect 11 further includes a shielding portion 20 overlapping another rim 12R.

This prevents field inversion caused by the field of view on an area adjacent to one rim 12R and allows the user 1 to recognize a virtual image formed by the image light as an image of the image light within only the field of view of an area adjacent to another rim 12L.

The above is a description of exemplary embodiments of the present invention. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A head-mounted display comprising:
a light source to emit image light; and
an optical component disposed opposite to a head, the optical component has multiple reflective surfaces arrayed in a first direction to reflect the image light to an eye in the head,
wherein at least two of the multiple reflective surfaces are disposed in a second direction tilted with respective to the first direction.

2. The head-mounted display according to claim 1,
wherein said at least two of the multiple reflective surfaces are parallel to each other in the second direction.

3. The head-mounted display according to claim 1,
wherein the optical component further has a transmissive surface,
the transmissive surface is between adjacent reflective surfaces of the multiple reflective surfaces, and
a first angle of incidence of the image light on the transmissive surface is greater than a second angle of incidence of the image light on one of the multiple reflective surfaces.

4. The head-mounted display according to claim 3,
wherein the transmissive surface is tilted with respect to the second direction to allow the first angle to be greater than the second angle.

5. The head-mounted display according to claim 1,
wherein the optical component is in a longitudinal direction orthogonal to a line of sight of the eye and parallel to the first direction.

6. The head-mounted display according to claim 5,
wherein the optical component is mounted on eyeglasses,
the optical component is in the longitudinal direction orthogonal to the line of sight of the eye at a position where the eye faces the eyeglasses.

7. The head-mounted display according to claim 1, further comprising:
a projection lens system to project the image light; and
an adjuster to adjust a position of the projection lens system.

8. The head-mounted display according to claim 1, further comprising:
a projection lens system to project the image;
a display element in series with the projection lens system; and
an adjuster that adjusts the position of the display element.

9. The head-mounted display according to claim 1,
wherein the optical component is between the eye and a lens of glasses mounting the head-mounted display.

10. The head-mounted display according to claim 1, further comprising a control board mounted on a temple of the glasses,
wherein the control board controls the optical element.

11. The head-mounted display according to claim 10,
wherein the control board includes a speaker.

12. Glasses comprising the head-mounted display according to claim 1.

13. The glasses according to claim 12, further comprising:
a first rim;
a second rim adjacent to the first rim; and
a shield adjacent to the second rim,
wherein the optical component is adjacent to the first rim.
